(19) United States
(12) Patent Application Publication
(10) Pub. No.: US 2015/0284608 A1
(43) Pub. Date: Oct. 8, 2015

(54) AMINE COMPOSITION FOR A CRASH-RESISTANT 2K EPOXY ADHESIVE

(71) Applicant: SIKA TECHNOLOGY AG, Baar (CH)

(72) Inventors: David Hofstetter, Winterthur (CH); Tina Voci, Zurich (CH); Jan Olaf Schulenburg, Uster (CH)

(21) Appl. No.: 14/440,418

(22) PCT Filed: Nov. 8, 2013
(86) PCT No.: PCT/EP2013/073338

§ 371 Date: May 4, 2015

(30) Foreign Application Priority Data
Nov. 12, 2012 (EP) 12192269.4

(51) Int. Cl. C09J 163/00; C08K 3/36

(52) U.S. Cl. CPC C09J 163/00; C08K 3/36

(57) ABSTRACT

The invention relates to a curing agent component for use in a two-component epoxy adhesive made of a component A including an epoxy resin and a curing agent component B, wherein the curing agent component B1) includes at least one aliphatic alicyclic polyether amine with at least 2 amino groups and B2) at least one polyamine selected from a phenalkylamine or an aliphatic polyether amine, containing at least one alicyclic alkoxylate segment and at least one cycloaliphatic segment, and optionally B3) at least one amine compound selected from an amine-terminated rubber, an amine-terminated poly(tetramethylene ether glycol) and an amine-terminated poly(tetramethylene ether glycol)-poly(propylene glycol) copolymer.

### FIELD OF TECHNOLOGY

The invention relates to a curing agent component for a two-component epoxy adhesive made from a component A comprising an epoxy resin and a curing agent component B, a two-component epoxy adhesive comprising the curing agent component and the use of the curing agent component in a two-component epoxy adhesive.

### PRIOR ART

In the manufacturing of motor vehicles and attached parts or machines and apparatus, high-grade adhesives are increasingly being used in place of or in combination with conventional attachment methods such as screwing, riveting, stamping or welding. When structural parts are bonded, high strength and impact strength of the adhesive are of the utmost importance.

Thermosetting epoxy adhesives have become established in vehicle manufacturing and in the area of vehicle repair; these are usually cured at temperatures of more than 100° C. and sometimes up to 210° C. However, their use is often disadvantageous, for example in the repair of vehicles in workshops that do not have the equipment required for thermosetting. In addition, the repair of vehicles, in contrast to their manufacturing, takes place on vehicles that are already fully equipped, so that heat-sensitive materials may also be affected.

The adhesives for the body shell should cure under the usual stoving conditions of ideally 30 min at 180° C. In addition, however, they should also be durable up to about 220° C. Additional requirements for such a cured adhesive or for bonding are those of guaranteeing operational reliability both at high temperatures up to about 90° C. and at low temperatures down to about −40° C.

Admittedly, conventional epoxy adhesives are characterized by high mechanical strength, especially high tensile strength. However, in the case of sudden stress, standard epoxy adhesives are usually too brittle and therefore are nowhere near to meeting the requirements under crash conditions in which both high tensile stress and peeling stress occur, especially in the automotive industry. Also insufficient in such cases are particularly the strengths at high temperatures, but especially at low temperatures (e.g., <−10° C.).

Essentially two methods are described in the literature for reducing the brittleness of epoxy adhesives and thus increasing the impact strength: on one hand, the goal can be accomplished by admixing at least partially crosslinked high molecular weight compounds such as latices of core/shell polymers or by using flexible polymers or copolymers that segregate into very small domains during hardening as impact strength modifiers (tougheners). On the other hand, a certain degree of flexibility may also be achieved by introducing soft segments, e.g., by appropriately modifying the epoxy components.

WO 2004/055092 A1 describes thermosetting epoxy resin compositions with improved impact strength by using an epoxy group-terminated impact strength modifier in the epoxy adhesive, wherein the impact strength modifier is obtained by reacting an isocyanate-terminated prepolymer with an epoxy resin having a primary or secondary hydroxy group-containing epoxy compound.

WO 2005/007720 A1 describes epoxy group-terminated impact strength modifiers obtained by reacting an isocyanate-terminated prepolymer with hydroxy group-bearing epoxy compounds, wherein the impact strength modifier has at least one aromatic structural element bound into the polymer chain by urethane groups.

The use of two or more different amines as curing agents in the curing agent component of structural two-component epoxy adhesives is known. As a rule, more than one amine is used to achieve different properties, e.g., to increase the elasticity of the cured adhesive.

In US 2009/0048730 A1, two-component epoxy adhesives comprising an epoxy resin and an impact strength modifier are described, in which the curing agent component is an amine composition containing B1) 15 to 40% of a primary or secondary amine-terminated polyether, B2) 4 to 40% of a primary or secondary amine-terminated rubber with a glass transition temperature of −40° C. or less and B3) 10 to 30% of a primary or secondary amine-terminated polyamide with a melting point of less than 50° C. The cured adhesives according to the examples have an impact peel resistance of about 20 and a tensile shear strength (TSS)<20 MPa.

Admittedly, quite good crash resistance (durability) is achieved with the two-component (2K) epoxy adhesive according to the prior art, but this is not on the level of a thermosetting one-component (1K) epoxy adhesive. In addition, the strength of the 2K adhesive is lower.

### PRESENTATION OF THE INVENTION

The object of the present invention is that of providing a 2K adhesive that should have the same or at least similar properties as those of a thermosetting 1K crash-resistant, structural adhesive. The 2K adhesives should be usable for making repairs at points where 1K thermosetting adhesives are used in the original assembly. The 2K adhesive differs in two points, among others. 1. The adhesive does not require thermosetting, but cures at room temperature and can optionally be further cured at temperatures up to 100° C. 2. As a rule, the adhesive is not applied to oiled substrates. After curing, the adhesive should be structurally durable and crash-resistant and exhibit good mechanical strength.

Surprisingly the object was achieved by means of a curing agent component for a two-component epoxy adhesive made of a component A comprising an epoxy resin and a curing agent component B, wherein the curing agent component B1) comprises at least one aliphatic acyclic polyether amine with at least 2 amino groups and B2) at least one polyamine selected from a phenalkamine or an aliphatic polyether amine containing at least one acyclic alkoxylate segment and at least one cycloaliphatic segment, and optionally B3) at least one amine compound selected from an amine-terminated rubber, an amine-terminated poly(tetramethylene ether glycol) and an amine-terminated poly(tetramethylene ether glycol)-poly(propylene glycol) copolymer.

With the curing agent component according to the invention in a 2K epoxy adhesive a cured adhesive composition can be obtained, which is structurally durable and crash-resistant and exhibits good mechanical strength. The invention will be explained in detail in the following.

Prepolymers are oligomeric compounds or even already polymeric compounds themselves which serve as precursors or intermediates for the synthesis of higher molecular weight substances. The prefix “poly” in expressions such as polyol, polyether or polyisocyanate means that the compound contains two or more of the groups mentioned; thus a polyamine is a compound with two or more amino groups. A polyether amine is a compound with two or more ether groups. The term “independent of one another” in connection with substituents, radicals or groups means that substituents, radicals or groups with the same name may be present simultaneously with different meanings within the same molecule.

The curing agent component for a two-component epoxy adhesive made from a component A comprising an epoxy resin and a curing agent component B comprises B1) one or more aliphatic alicyclic polyether amines with at least 2 amino groups. The aliphatic alicyclic polyether amine in particular has at least 2 primary or secondary amino groups, with primary amino groups being preferred. This preferably involves a polyether amine with 2 or 3 amino groups, particularly preferably a polyether amine with 2 amino groups. Particularly preferably the aliphatic alicyclic polyether amine is a primary diamine. Such polyether amines are commercially available. The aliphatic alicyclic polyether amine preferably contains ethoxylate and/or propoxylate groups.

The aliphatic alicyclic polyether amine is preferably a relatively small polyamine compound. For example, an aliphatic alicyclic polyether amine with a molecular weight of no more than 320 and particularly preferably no more than 240 is preferred.

Preferred examples of the aliphatic alicyclic polyether amines B1 are 4,7-dioxaoctane-1,10-diamine (Jeffamine®EDR 176 from Huntsman), 3,6-dioxaoctane-1,8-diamine (Jeffamine®EDR 148 from Huntsman), 4,7-dioxadecane-1,10-diamine, 4,7-dioxadecane-2,9-diamine, 4,9-dioxadodecane-1,12-diamine (available as Baxxadur®EC280 from Bayer), 5,8-dioxadodecane-3,10-diamine, 4,7,10-trioxatridecane-1,13-diamine (available as Ancamine®1922A from Air Products or as Baxxadur® EC130 from Bayer) and higher oligomers of these diamines.

The curing agent component for a two-component epoxy adhesive made of a component A comprising an epoxy resin and a curing agent component B also comprises B2) one or more polyamines selected from a phenalkamine and an aliphatic polyether amine containing at least one alicyclic alkoxylate segment and at least one cycloaliphatic segment.

Phenalkamines are phenol alkanamines, the use of which as epoxy curing agents is known and which are commercially available. These are generally semisynthetic products based on condensation products of cardanol for example with aliphatic amines or polyamines, for example ethylene diamine or diethyl triamine, and aldehydes such as formaldehyde (Mannich bases). Cardanol is an alkylphenol and the main constituent of an oil from cashew nut shells (CNSL). Examples of commercial products are, for example, Lapox® phenalkylamines from Bodo Möller Chemie, Aradur®3460, Aradur®3440 or Aradur®3442 from Huntsman or the Paladin types such as PPA-7090, PPA-7124, PPA-7125 and PPA-7140. Several phenalkamine curing agents are also available from Cardolite, for example under the names of NC-540, NC-541LV and LITE 2001.

Alternatively the polyamine B2) used may be an aliphatic polyether amine containing at least one alicyclic alkoxylate segment and at least one cycloaliphatic segment. The at least one alicyclic alkoxylate segment can be one or more ethoxylate groups, one or more propoxylate groups or a mixture of ethoxylate, butoxylate and propoxylate groups. The aliphatic polyether amine preferably contains propoxylate groups. The cycloaliphatic segment may be one or more cycloaliphatic groups. The cycloaliphatic segment is preferably located in the main chain of the polyether amine, but can also be located in a side chain. Examples of the cycloaliphatic segment are cyclopentyl, cyclohexyl and bicyclo-[4.4.0]decanyl. This is preferably an amine-terminated cycloaliphatic ethoxylate and particularly preferably an amine-terminated cycloaliphatic propoxylate. These compounds are also commercially available, for example as Jeffamine®RFD-270 from Huntsman.

The curing agent component for a two-component epoxy adhesive made of a component A comprising an epoxy resin and a curing agent component B can optionally contain a third amine component B3). The optional amine component B3) can be one or more amine compounds selected from an amine-terminated rubber, an amine-terminated poly(tetramethylene ether glycol) and an amine-terminated poly(tetramethylene ether glycol)-poly(propylene glycol) copolymer. These compounds are also customary curing agent components that are commercially available.

Amine-terminated rubbers are, for example, homopolymers or copolymers of one or more conjugated dienes with amino end groups; diene/nitrile copolymers are preferred. The diene is preferably butadiene or isoprene, preferably butadiene. The preferred nitrile is acrylonitrile. Butadiene/acrylonitrile copolymers are preferred.

The amine groups are preferably primary or secondary amine groups. The number of amino groups and the molecular weight of the rubber can vary within broad limits. The amine-terminated rubber contains, for example, about 1, preferably more than 1, preferably more than 1.5 and preferably no more than 2.5 primary or secondary amino groups per molecule on average. The weight average molecular weight, determined by GPC, can for example fall in the range of 2000 to 6000. Typical commercial products for these amine-terminated rubbers are the various ATBN® products from Emerald Performance Materials, for example ATBN® 1300X16 or analogous products.

Surprisingly, in place of the amine-terminated rubber, the optional third amine component used may also be amine-terminated poly(tetramethylene ether glycol) or amine-terminated poly(tetramethylene ether glycol)-poly(propylene glycol) copolymer. These are also sold commercially. A marketed amine-terminated poly(tetramethylene ether glycol) for example is Jeffamine®THF-170. A marketed amine-terminated poly(tetramethylene ether glycol)-poly(propylene glycol) copolymer is for example Jeffamine®THF-100.

In the curing agent component, the weight ratio of the amine component B1, i.e., of at least one aliphatic alicyclic polyether amine with at least 2 amino groups, to the amine component B2, i.e., at least one polyamine selected from a phenalkylamine and an aliphatic polyether amine that contains at least one alicyclic alkoxylate segment and at least one cycloaliphatic segment, can vary over a wide range. For example, the weight ratio of amine component B1 to amine component B2 in the curing agent component B may fall within the range of 2:1 to 1:3, preferably from 2:1 to 1:2 and particularly preferably from 1:1 to 1:2.

The amines B1 to B3 mentioned can also be used in the form of an adduct with an epoxy resin. Such adducts and their use in a curing agent component are generally known to the person skilled in the art. Suitable epoxy resins for producing the adducts include all customary epoxy resins and those described here. If such epoxy resin adducts are used, the epoxy resin fraction is not considered for the fractions or proportions of the respective amines mentioned in the present application.

The curing agent component, in addition to the obligatory amine components B1 and B2 well as the optional curing agent component B3, may optionally include one or more additives that are customary for such curing agent components. Examples of such customary additives are other amine components used as curing agents, fillers, thixotropic additives, adhesive promoters, impact strength modifiers, accelerators and other additives.

Theoretically suitable additives such as fillers, thixotropic additives, adhesive promoters, impact strength modifiers and other additives are all those that may be added to the epoxy resin-containing component A. Therefore the reference is made to the description and the examples that follow with respect to these additives for the epoxy resin-containing component A, which apply similarly for these additives in the curing agent component unless explicitly stated otherwise. Accelerators that may be used if necessary include any of those customarily used in the industry. Such accelerators are commercially available.

Examples of accelerators that accelerate the reaction between amino groups and epoxy groups are, for example, acids or compounds that can be hydrolyzed to form acids, for example organic carboxylic acids such as acetic acid, benzoic acid, salicylic acid, 2-nitrobenzoic acid, lactic acid, organic sulfonic acids such as methanesulfonic acid, p-toluenesulfonic acid or 4-dodecylbenzenesulfonic acid, sulfonic acid esters, other organic or inorganic acids such as phosphoric acid, or mixtures of the above-named acids and acid esters; tertiary amines such as 1,4-diazabicyclo[2.2.2]octane, benzyl-dimethylamine, □-methylbenzyl dimethylamine, triethanolamine, dimethylamino propylamine, salts of such tertiary amines, quaternary ammonium salts, for example benzyltrimethyl ammonium chloride, phenols, especially bisphenols, phenolic resins and Mannich bases, for example 2-(dimethylaminomethyl)phenol and 2,4,6-tris-(dimethyl-aminomethyl)phenol, phosphites such as di- and triphenyl phosphites, as well as mercapto group-containing compounds.

The curing agent component according to the invention is suitable as a curing agent component in a two-component epoxy adhesive made of a component A comprising an epoxy resin and a curing agent component B. Component A of the two-component epoxy adhesive comprises one or more epoxy resins. Component A also preferably comprises one or more impact strength modifiers. Component A can also optionally contain other additives such as those that are customary for epoxy resin adhesives. Examples of optional additives are fillers, thixotropic additives and adhesive promoters as well as other additives.

In a preferred embodiment, the curing agent component has the following composition:

10 to 20 wt. % aliphatic alicyclic polyether amines B1),

15 to 40 wt. % polyamine B2),

0 to 20 wt. % amine compound B3), preferably 5 to 20 wt. %,

0 to 50 wt. % fillers and/or thixotropic additives, preferably 5 to 50 wt. %

0 to 5 wt. % adhesive promoters and/or additional additives and

0 to 5 wt. % accelerators, preferably 2 to 5 wt. %.

The preferred curing agent component can be used with any epoxy resin-containing component A as a two-component epoxy adhesive. Preferably the curing agent component, especially the preferred curing agent component with the composition mentioned in the preceding, is used with a component A that has the following components

40 to 80 wt. % of at least one epoxy resin,

5 to 40 wt. % of at least one impact strength modifier,

0 to 50 wt. % fillers and/or thixotropic additives, preferably 5 to 50 wt. %, and

0 to 5 wt. % adhesive promoters and/or additional additives.

In the following, the components and possible additives will be described in further detail. Unless specified otherwise, the following information applies both for the curing agent component and for component A.

The epoxy resin in the epoxy resin component A preferably has, on average, more than one epoxy group per molecule. The epoxy resin is particularly a liquid epoxy resin or a solid epoxy resin. The term “solid epoxy resin” is very well known to the epoxy expert and is used in contrast to “liquid epoxy resins”. The glass transition temperature of solid resins is above room temperature, i.e., they can be ground to form free-flowing powders at room temperature.

Advantageous liquid epoxy resins or solid epoxy resins are, for example, the diglycidyl ethers of Formula (I)

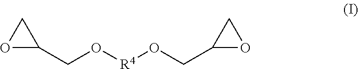

wherein R⁴ represents a divalent aliphatic or mononuclear aromatic or a dinuclear aromatic residue.

Examples of Diglycidyl Ethers of Formula (I) are
Diglycidyl ethers of difunctional saturated or unsaturated, branched or unbranched, cyclic or open-chain C₂-C₃₀ alcohols, for example ethylene glycol, butanediol, hexanediol or octanediol glycidyl ether, cyclohexane dimethanol diglycidyl ether, neopentyl glycol diglycidyl ether;
Diglycidyl ethers of difunctional, low- to high-molecular-weight polyether polyols such as polyethylene glycol diglycidyl ether, polypropylene glycol diglycidyl ether;
Diglycidyl ethers of difunctional diphenols and optionally triphenols, wherein this is understood to include not only pure phenols, but optionally also substituted phenols. The method of substitution can vary widely. In particular, this is understood to include substitution directly on the aromatic ring to which the phenolic OH group is attached. Phenols also include not only include mononuclear aromatics, but also polynuclear or condensed aromatics or heteroaromatics which have the phenolic OH group bound directly to the aromatic or heteroaromatic. Suitable bisphenols and optionally triphenols are, for example, 1,4-dihydroxybenzene, 1,3-dihydroxybenzene, 1,2-dihydroxybenzene, 1,3-dihydroxytoluene, 3,5-dihydroxybenzoate, 2,2-bis(4-hydroxyphenyl) propane (=bisphenol A), bis(4-hydroxyphenyl) methane (=bisphenol F), bis(4-hydroxyphenyl) sulfone (=bisphenol S), naphthoresorcinol, dihydroxynaphthalene, dihydroxyanthra-quinone, dihydroxy-biphenyl, 3,3-bis(p-hydroxyphenyl)phthalide, 5,5-bis(4-hydroxyphenyl)hexahydro-4,7-methanoindane, phenolphthalein, fluorescein, 4,4′-[bis-(hydroxyphenyl)-1,3-phenylenebis-(1-methyl-ethylidene)] (=bisphenol M), 4,4′-[bis-(hydroxyphenyl)-1,4-phenylenebis-(1-methyl-ethylidene)] (=bisphenol P), 2,2′-diallyl-bisphenol A, diphenols and dicresols prepared by reacting phenols or cresols with diisopropylidene benzene, phloroglucinol, bile acid esters, phenol or cresol novolaks with —OH-functionality of 2.0 to 3.5 and all isomers of the aforementioned compounds.

Preferred Solid Epoxy Resins have Formula (II)

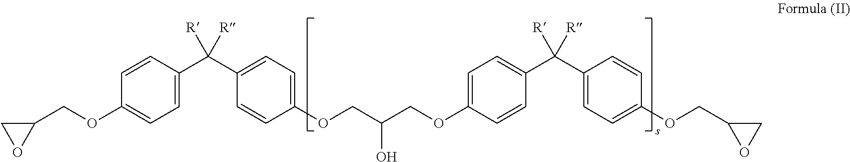

Here, the substituents R′ and R″ independently of one another are either H or CH₃. Furthermore, the subscript s represents a value of >1.5, especially of 2 to 12.

Such solid epoxy resins are commercially available, for example from Dow or Huntsman or Hexion.

Compounds of Formula (II) with a subscript s of between 1 and 1.5 are known by the person skilled in the art as semisolid epoxy resins. For the present invention they are also known as solid resins. However, solid epoxy resins in the narrower sense are preferred, i.e., where the subscript s has a value of >1.5.

Preferred Liquid Epoxy Resins have Formula (III)

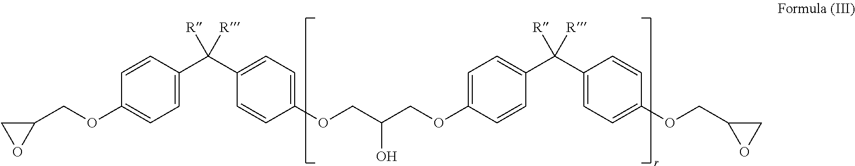

Here, the substituents R′″ and R″″ independently of one another represent either H or CH₃. In addition, the subscript r represents a value of 0 to 1. Preferably, r represents a value of less than 0.2.

Thus these are preferably diglycidyl ethers of bisphenol A (DGEBA), bisphenol F and bisphenol A/F. The designation A/F in this connection refers to a mixture of acetone with formaldehyde, which is used as an educt in manufacturing it. Such liquid resins are available, for example, as Araldite® GY 250, Araldite® PY 304, Araldite® GY 282 or D.E.R.® 331 or D.E.R.® 330 (Dow) or Epikote® 828 (Hexion).

Also suitable as epoxy resin A are so-called novolacs. These have the following formula, in particular:

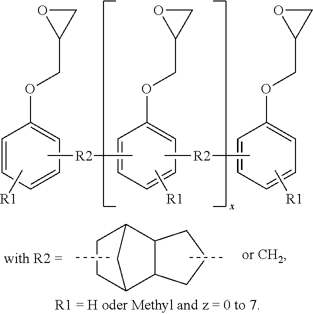

In particular, they are phenol or cresol novolacs (R2=CH₂). Such epoxy resins are commercially available under the trade names EPN or ECN and Tactix®556 from Huntsman or in the product series D.E.N.® from Dow Chemical.

One or more impact strength modifiers may be used in component A and optionally in the curing agent, component B. The use of such compounds, which even at low rates of addition to an epoxy resin matrix can result in a distinct increase in the durability of the cured matrix, are familiar to the person skilled in the art. All customary impact strength modifiers may be used, alone or in a mixture. Examples of suitable impact strength modifiers are listed for example in WO 2004/055092, WO 2005/007720 and WO 2011/107450 which are herewith incorporated by reference.

Preferably at least one impact strength modifier selected from

a) a liquid rubber containing an epoxy group-terminated impact strength modifier, which can be obtained from the reaction of an isocyanate-terminated prepolymer with an epoxy resin which comprises a primary or secondary hydroxy group-containing epoxy compound,

b) a core-shell polymer, particularly consisting of a core made of elastic acrylate or butadiene polymer and a shell of a rigid thermoplastic polymer and/or

c) a core-shell rubber

is used.

The liquid rubber a) used as impact strength modifier is preferably obtainable by reacting an isocyanate-terminated prepolymer of Formula (IV)

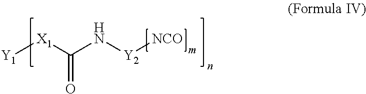

wherein X₁=O, S or NH;

Y₁ stands for the n-valent residue of a reactive polymer after the removal of terminal amino-, thiol or hydroxyl groups;

Y₂ stands for a divalent residue of aliphatic, cycloaliphatic, aromatic or araliphatic diisocyanates after removal of the isocyanate groups, or for a trivalent residue of trimers or biurets of aliphatic, cycloaliphatic, aromatic or araliphatic diisocyanates after removal of the isocyanate groups;

m=1 or 2; and

n=2, 3 or 4; preferably 2 or 3,
with at least one epoxy resin comprising a primary or secondary hydroxy group-containing epoxy compound of Formula (V)

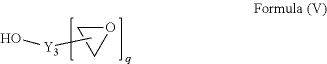

wherein Y₃ stands for a residue of an aliphatic, cycloaliphatic, aromatic or araliphatic epoxide containing a primary or secondary hydroxyl after removal of the epoxy groups and the primary or secondary hydroxyl group; and

q=1, 2 or 3;
in the presence of at least one compound selected from anhydrides, ketones and aldehydes as glycol scavenger, wherein the isocyanate-terminated prepolymer of Formula (IV), the epoxy resin and the glycol scavenger are mixed together or the epoxy resin is reacted with the glycol scavenger before they are mixed with the isocyanate-terminated prepolymer of Formula (IV).

The isocyanate-terminated prepolymer is preferably a reaction product of one or more X₁H group-bearing compounds of Formula (VI) and one or more polyisocyanates of Formula (VII), wherein the substituents and subscripts are defined in the same way as in Formula (IV).

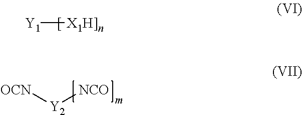

X₁H group-bearing compounds of Formula (VI) that may be considered are all those customarily used in the area. Examples of X₁H group-bearing compounds of Formula (VI) are polyether polyols, polybutadiene polyols, polyester polyols, polycarbonate polyols, NH-terminated polyethers and mixtures thereof. Particularly preferred compounds of Formula (VI) are □,ω-polyalkylene glycols with C₂-C₆-alkylene groups or with mixed C₂-C₆-alkylene groups terminated with amino, thiol or hydroxyl groups, preferably hydroxyl groups. Particularly preferred are polyether polyols such as hydroxyl group-terminated polyoxyethylene, polyoxybutylene and polyoxypropylene, as well as mixtures of these and hydroxyl group-terminated polybutadiene and amine-terminated polyether.

In a preferred embodiment a mixture of at least two, preferably two or three compounds of Formula (VI) are used as compounds of Formula (VI), namely at least one polyether polyol in combination with at least one OH-terminated rubber, wherein the weight ratio of polyether polyol to OH-terminated rubber is in the range of 7:3 to 2:8. This can improve the mechanical properties. The polyether polyols and OH-terminated rubbers named in the following are not only suitable for use in combination, but may also be used alone if desired.

Preferred polyether polyols are polymerization products of ethylene oxide, 1,2-propylene oxide, 1,2- or 2,3-butylene oxide, tetrahydrofuran or mixtures thereof, polypropylene oxides and polytetrahydrofurans are particularly preferred. Such polyether polyols are commercially available. Commercially available polytetrahydrofurans are, for example, the polyTHF®-products from BASF such as polyTHF®2000, polyTHF®2500 CO or polyTHF®3000 CO. Commercially available polypropylene oxides are, for example, Caradol®-products from Shell, such as Caradol®2000 or Caradol®ED56, or Acclaim®-products from Bayer, such as Acclaim®-polyol 2200, Acclaim®-polyol 12200 or Acclaim®-polyol 4200. Additional possible polyether polyols are Voranol®1010L, Voranol® EP1900 Voranol®CP4755 from Dow.

The average molecular weight of the polyether polyols used can vary. The polyether polyols have, for example, a weight-average molecular weight (Mw) in the range of 500 to 5000 g/mol, more preferred 1000 to 3000 g/mol and particularly preferably in the range of 1500 to 2500 g/mol, especially about 2000 g/mol.

Unless stated otherwise, in the present application the weight-average molecular weight is determined by the GPC method. For this purpose, different separating columns are used, depending on the polymer to be determined: columns: SDV 100, 1000, 10⁴ Å, (0.8×30 cm, 5 μm); eluent: THF; flow rate: 1 mL/min; temperature: 35° C.; calibration relative to poly(1,4-butadiene) standards: 831-1,060,000 g/mol; Sample preparation: approx. 100 mg sample were dissolved in 10 mL THF and filtered with a 0.45 μm PTFE membrane filter.

The OH functionality of the polyether polyols used is preferably in the range of about 2, for example the range of 1.9 to 2.1. Optionally a compound with an OH functionality of 3, such as butoxylated trimethylolpropane (for example Simulsol®TOMB), can be mixed with the polyether polyol to increase the OH functionality.

For example, the OH functionality can be measured by titration. The hydroxyl group-containing substance is reacted with an excess of diisocyanate, and after the reaction, the excess isocyanate is determined titrimetrically using 0.1 M HCl solution and the hydroxyl number is calculated.

One or more OH-terminated rubbers can be used, wherein the use of two OH-terminated rubbers, especially two OH-terminated polybutadienes, can result in particularly favorable properties. Here and preferably, for example, OH-terminated rubbers are defined as hydroxyl-terminated polybutadienes and castor oil-based polyols, wherein hydroxyl-terminated polybutadienes are particularly preferred. Castor oil is a triglyceride, the OH functionality of which is based on the hydroxy group of ricinoleic acid, and therefore it represents a polyol. Castor oil is a natural product available in various grades, for example in standard grade, as a dehydrated product or with a very low acid number. Derivatized castor oil products are also available, for example oxidatively polymerized castor oil or partially dehydrated castor oil, with which for example a lower OH functionality can be established. Castor oil-based polyols comprise castor oil in various grades and castor oil derivatives.

Commercially available hydroxyl-terminated polybutadienes are, for example, the poly Bd® and Krasol® products from Cray Valley, such as Krasol® LBH-P 2000 or poly Bd® R45V. Castor oil-based polyols are, for example, the Albodur® products from Alberdingk Boley, for example Albodur®901, or the Polycine® products from Baker Castor Oil Company, such as Polycine® GR80.

The hydroxyl-terminated rubbers used preferably have a weight-average molecular weight (Mw) of less than 15,000 g/mol and preferably less than 4.000 g/mol.

The OH functionality of the hydroxyl-terminated rubbers used preferably falls in the range of 1.7 to 2.2 for anionically produced types or of 2.2 to 2.8 for types produced using free radical methods. It is preferred to use a hydroxyl-terminated rubber, especially a hydroxyl-terminated butadiene, with an OH functionality of less than or equal to 2.

If a mixture of polyether polyol and hydroxyl-terminated rubber is used, the weight ratio of polyether polyol to hydroxyl-terminated rubber is preferably in the range of 7:3 to 2:8, more preferably 7:3 to 4:6, and particularly preferably 7:3 to 5:5. In this way the mechanical properties of the cured adhesive can be improved, especially the impact peel resistance at −30° C.

Suitable polyisocyanates of Formula (VII) are diisocyanates or triisocyanates. Suitable diisocyanates are aliphatic, cycloaliphatic, aromatic or araliphatic diisocyanates, especially customary commercial products such as methylenediphenyl diisocyanate (MDI), hexamethylene diisocyanate (HDI), toluene diisocyanate (TDI), tolidine diisocyanate (TODI), isophorone diisocyanate (IPDI), trimethyl hexamethylene diisocyanate (TMDI), 2,5- or 2,6-bis-(isocyanatomethyl)-bicyclo[2.2.1]heptane, 1,5-naphthalene diisocyanate (NDI), dicyclohexyl methyldiisocyanate (H₁₂MDI), p-phenylene diisocyanate (PPDI), m-tetramethylxylylene diisocyanate (TMXDI) etc. as well as dimers thereof. HDI, IPDI, MDI or TDI are preferred.

The epoxy resin, comprising a primary or secondary hydroxy group-containing epoxy compound of Formula (V), to be reacted with the isocyanate-terminated prepolymer can be an epoxy resin or a mixture of two or more epoxy resins. The epoxy resin is preferably a liquid epoxy resin. The epoxy resin or the liquid epoxy-resin may be a commercially available epoxy resin product. In particular, the epoxy resins used may be those which were already described in the preceding as epoxy resins for use in component A, as long as these contain an epoxy compound of Formula (V). However, this is usually the case. Therefore reference is made to the above-mentioned examples for epoxy resins.

In particular, epoxy resins are usually obtained from the reaction of an epoxy compound, for example epichlorohydrin, with a polyfunctional alcohol, i.e., a diol, triol or polyol. Depending on the reaction management, in the reaction of polyfunctional alcohols with an epoxy compound, for example epichlorohydrin, byproducts produced also include the corresponding hydroxy-epoxy compounds in different concentrations. As a rule, the epoxy resins are product mixtures of polyol completely and partially reacted to form glycidyl ether obtained during the glycidylation reaction of polyols. Examples of such hydroxyl-containing epoxies in epoxy resins are trimethylolpropane diglycidyl ether contained as an admixture in trimethylolpropane triglycidyl ether, glycerol diglycidyl ether contained as an admixture in glycerol-triglycidyl ether, and pentaerythritol triglycidyl ether contained as an admixture in pentaerythritol tetraglycidyl ether.

Particularly preferred are the above-described epoxy resins based on diglycidyl ethers of bisphenol A (BADGE), bisphenol F or bisphenol A/F according to Formulas (II) or (III).

The reaction of the isocyanate prepolymers of Formula (IV) and the epoxy resins comprising a primary or secondary hydroxy group-containing epoxy compound of Formula (V), is preferably performed in the presence of at least one anhydride, ketone or aldehyde as a glycol scavenger, wherein anhydrides are preferred. Preferred anhydrides are succinic anhydride, phthalic anhydride and derivatives thereof, especially methylphthalic acid anhydride. The anhydride preferably comprises the succinic anhydride ring or maleic anhydride ring as a structural element. Examples of ketones and aldehydes are formaldehyde, acetone, cyclopentanone and benzaldehyde.

In one embodiment this additional impact strength modifier (IM) is a liquid rubber (IM1), which is a carboxyl- or epoxide-terminated acrylonitrile/butadiene copolymer or a derivative thereof. Liquid rubbers of this type, for example, are commercially available under the name of Hypro® (previously Hycar®) CTBN and CTBNX and ETBN from Emerald Performance Materials LLC. Particularly suitable derivatives are epoxy group-containing elastomer-modified prepolymers, such as those sold commercially under the Polydis® product line, particularly from the product line Polydis® 36, from the Struktol® Company (Schill+Seilacher Group, Germany) or under the product line Albipox® (Evonik Hanse GmbH, Germany). In an additional embodiment, the impact strength modifier (IM) is a polyacrylate liquid rubber (IM1) that is completely miscible with liquid epoxy resins and only segregates into micro-droplets during curing of the epoxy resin matrix. Polyacrylate liquid rubbers of this type are available, for example, under the name of 20208-XPA from Rohm and Haas.

An additional example of a preferably used impact strength modifier is one or more core-shell polymers, especially core-shell polymer particles. Core-shell polymers consist of an elastic core polymer and a rigid shell polymer. Particularly suitable core-shell polymers consist of a core made of elastic acrylate or butadiene polymer surrounded by a shell made of a rigid thermoplastic polymer. This core-shell structure forms either spontaneously by segregation, or self-organization, of a block copolymer or is pre-established by the polymerization reaction control as a latex or suspension polymerization followed by grafting.

Preferred core-shell polymers are so-called MBS polymers, which are commercially available under the trade name of Clearstrength® from Atofina, Paraloid® from Rohm and Haas or F-351® from Zeon. Particularly preferred are core-shell polymer particles that already exist in the form of dried polymer latex. Examples of this are GENIOPERL®M23A from Wacker with polysiloxane core and acrylate shell, radiation-crosslinked rubber particles of the NEP series, produced by Eliokem or Nanoprene® from Lanxess or Paraloid® EXL from Rohm and Haas. Additional comparable examples of core-shell polymers are sold under the name of Albidur® by Nanoresins AG, Germany.

An additional example of a preferably used impact strength modifier is one or more core-shell rubbers, especially core-shell rubber particles. These are described for example in EP 1 632 533 A1. The core-shell rubber particles contain a crosslinked rubber core, in most cases a crosslinked butadiene copolymer, and a shell, which is in particular a copolymer made of styrene, methyl methacrylate, glycidyl methacrylate and optionally acrylonitrile. The core-shell rubber is preferably dispersed in a polymer or an epoxy resin.

Preferred core-shell rubbers comprise products sold by the Kaneka Corporation under the name of Kaneka Kane Ace, for example Kaneka Kane Ace®MX 156 and Kaneka Kane Ace®MX 120 core-shell rubber dispersions. The products contain the core-shell rubber particles predispersed in an epoxy resin, usually at a concentration of about 25%. When dispersions such as these are used, the epoxy resin contained in these products is all or part of the epoxy resin component of the adhesive of the invention.

Optionally one or more fillers may be used. Fillers for component A or the curing agent component can be all those customarily used in this area. Examples are mica, talc, kaolin, wollastonite, feldspar, syenite, chlorite, bentonite, montmorillonite, calcium carbonate (precipitated or ground), dolomite, quartz, silicas (pyrogenic or precipitated), cristobalite, calcium oxide, aluminum hydroxide, magnesium oxide, hollow ceramic beads, hollow glass beads, hollow organic beads, glass beads, colored pigments. Both organic coated and uncoated fillers are commercially available and are known to the person skilled in the art.

Optionally one or more thixotropic additives or rheology modifiers may be used. Thixotropic additives for component A or the curing agent component may be all the customary ones used in this area. Examples are, for example, phyllosilicates such as bentonite, derivatives of castor oil, hydrogenated castor oil, polyamides, polyurethanes, urea compounds, pyrogenic silicas, cellulose ethers and hydrophobically modified polyoxyethylenes.

Optionally one or more adhesive promoters may be used. Adhesive promoters used for component A or the curing agent component may be all customary adhesive promoters used in this area. Examples are organoalkoxysilanes such as 3-glycidoxypropyl-trimethoxysilane, 3-aminopropyltrimethoxysilane, N-(2-aminoethyl)-3-aminopropyltrimethoxysilane, N-(2-aminoethyl)-N′-[3-(trimethoxysilyl)propyl]ethylene diamine, 3-ureidopropyl trimethoxysilane, 3-chloropropyl trimethoxysilane, vinyl trimethoxysilane, or the corresponding organosilanes with ethoxy groups or (poly)etheroxy groups in place of the methoxy groups.

Optionally additional additives may also be present as additives in component A or component B. These are included among the additional additives in terms of the aforementioned weight ratios. Examples are
Solvents, coalescing aids or extenders, such as toluene, xylene, methylethyl ketone, 2-ethoxyethanol, 2-ethoxyethyl acetate, benzyl alcohol, ethylene glycol, diethylene glycol butyl ether, dipropylene glycol butyl ether, ethylene glycol butyl ether, ethylene glycol phenyl ether, N-methylpyrrolidone, propylene glycol butyl ether, propylene glycol phenyl ether, diphenylmethane, diisopropyl naphthalene, petroleum fractions such as Solvesso types (from Exxon), aromatic hydrocarbon resins, especially phenol group-containing types, sebacates, phthalates, organic phosphorus and sulfonic acid esters and sulfonamides; and
Reactive diluents, for example epoxy-reactive diluents, epoxidized soy oil or linseed oil, acetoacetate group-containing compounds, especially acetoacetylated polyols, butyrolactone, as well as isocyanates and reactive group-containing silicones,
Stabilizers against oxidation, heat, light and UV radiation,
Flame retardant substances,
Surface-active substances, for example wetting agents, leveling agents, deaerating agents or defoamers, and
Biocides, for example algicides, fungicides or fungal growth-inhibiting substances.

Component B is advantageously used as a curing agent component in a two-component epoxy adhesive. The two-component epoxy adhesive can be used for bonding substrates. For this purpose, component A and the curing agent component B are mixed in the customary manner and then applied to one or both of the substrates to be bonded.

Then the parts to be bonded are put together, after which the adhesive cures. In this process it is necessary to make sure that the parts are put together within the so-called open time to guarantee that the two parts being bonded will bond together reliably. The curing of the epoxy resin composition can take place at the customary temperatures, for example at a temperature of 100° C. or less, preferably of 60 to 85° C.

The substrates to be bonded can be the same or different. Suitable substrates are, for example, inorganic substrates such as glass, glass-ceramics, concrete, mortar, brick, tile, gypsum and natural stones such as granite or marble; metals or alloys such as aluminum, steel, nonferrous metals, galvanized metals; organic substrates such as wood, plastics such as PVC, polycarbonates, PMMA, polyesters, epoxy resins, glass fiber reinforced plastic (GFP), carbon fiber reinforced plastic (CFP); coated substrates such as powder-coated metals or alloys; and paints and lacquers, especially automobile top coats. Particularly preferably the two-component epoxy adhesive is used for bonding metal, plastic or fiber-composite surfaces.

The two-component epoxy adhesive is especially suitable for the repair or bonding of vehicle parts, especially automobile parts, metal components, plastics or windmill blades.

Examples of vehicles are automobiles, trucks, buses, rail vehicles, aircraft and ships. Bonding in vehicle construction includes for example the attachment of parts, such as plastic covers, decorative strips, flanges, bumpers, driver cabs or other attachments, to the painted body of a vehicle, or the bonding of window panes into the body. In a preferred embodiment the two-component epoxy adhesive is used as a two-component repaid adhesive in vehicle construction, especially for automobiles.

### EXAMPLES

In the following, examples will be presented to further illustrate the invention, but these are not intended to limit the scope of the invention in any way. Unless stated otherwise, all parts and percentages are by weight.

| Raw materials used | Description | |
|---|---|---|
| Epikote ® 828LVEL | Standard bisphenol A-epoxy | Hexion |
| | resin | |
| HDK 18 | Pyrogenic silica | Wacker |
| Toughener | Reactive liquid rubber | Sika |
| | containing epoxy group- | |
| | terminated impact strength | |
| | modifier made of an | |
| | isocyanate-terminated | |
| | prepolymer and an epoxy resin | |
| Ancamine ®1922A | 4,7,10-Trioxatridecane-1,13- | Air Products |
| | diamine | |
| Jeffamine ®RFD-270 | Amine-terminated cycloaliphatic | Huntsman |
| | propoxylate | |
| Aradur ®3460 | Phenalkylamine | Huntsman |
| A-187 | Epoxysilane | Crompton |
| ATBN ® 1300x16 | Amine-terminated rubber | Emerald |
| | | Performance |
| | | Materials |
| Jeffamine ®THF-170 | Amine-terminated poly(tetra- | Huntsman |
| | methylene ether glycol) | |
| Jeffamine ®THF-100 | Amine-terminated | Huntsman |
| | poly(tetramethylene ether | |
| | glycol)-poly(propylene glycol)- | |
| | copolymer | |
| Accelerator ®2950 | Accelerator | Huntsman |

The components were mixed together in the usual manner in the quantities shown in the tables below to obtain component A and the curing agent component B. To test the properties, the two components were mixed in a 1:1 equivalent ratio of NH-equivalent weight to epoxy equivalent weight and cured. The prepared epoxy adhesives were evaluated using the following tests. The results are also presented in the tables below.

Tensile Shear Strength (TSS) (DIN EN 1465)

The test pieces were prepared from the compositions described and with galvanized H420 steel (eloZn) with dimensions of 100×25×1.5 mm. The bonding surface was 25×10 mm at a layer thickness of 0.3 mm. Curing was performed for 4 h at RT+30 min at 85° C. The traction speed was 10 mm/min.

Impact Peel Resistance (I-Peel) (ISO 11343)

The test pieces were prepared from the compositions described and with galvanized DC04 steel (eloZn) with dimensions of 90×20×0.8 mm. The bonding surface was 20×30 mm at a layer thickness of 0.3 mm. Curing was performed either for 7 d at RT or 4 h at RT+30 min at 85° C. The measurement of the impact peel resistance was performed once at room temperature and once at minus 30° C. The impact speed was 2 m/s. The impact peel resistance in N/mm is reported as the area under the measurement curve (from 25% to 90%, stated according to ISO 11343).

Modulus of Elasticity (DIN EN ISO 527)

A sample of the composition was pressed between two Teflon sheets to a layer thickness of 2 mm. Then the composition was cured for 4 h at RT+30 min at 85° C. The Teflon sheets were removed and the test pieces according to the DIN standard were punched out while still hot. The test pieces were measured after 1 day of storage at standard climate with a tensile speed of 2 mm/min. The modulus of elasticity was determined according to DIN EN ISO 527.

A-component A1

| Raw material | A1 |
|---|---|
| A Toughener | 30 |
| B Epoxy resin Epikote ®828 LVEL | 65 |
| C Filler HDK 18 | 5 |

B-components B1 to B6

| Raw material | B1 | B2 | B3 | B4 | B5 | B6 |
|---|---|---|---|---|---|---|
| B1 Amine Ancamine ®1922 | 63 | 47.5 | 32 | 63 | 47.5 | 32 |
| B2 Amine Jeffamine ®RFD-270 | 32 | 47.5 | 63 | | | |
| B2 Amine Aradur ®3460 | | | | 32 | 47.5 | 63 |
| C Filler HDK 18 | 5 | 5 | 5 | 5 | 5 | 5 |

Results

| | A1 + | A1 + | A1 + | A1 + | A1 + | A1 + |
|---|---|---|---|---|---|---|
| Test | B1 | B2 | B3 | B4 | B5 | B6 |
| Modulus of elasticity¹ | 1130 | 1050 | 1030 | 930 | 1070 | 990 |
| TSS¹ | 24 | 21 | 24 | 21 | 21 | 22 |
| I-Peel¹ at 23° C. | 18 | 24 | 30 | 11 | 9 | 5 |
| I-Peel¹ −30° C. | 26 | 24 | 24 | 13 | 2 | 1 |
| I-Peel² at 23° C. | 26 | 28 | 33 | 18 | 9 | 11 |

¹Curing 4 h RT + 30 min 85° C.
²Curing 7 d RT

A-component A2

| Raw material | A2 |
|---|---|
| A Toughener | 23 |
| B Epoxy resin Epikote ®828 LVEL | 70 |
| C Filler HDK 18 | 5 |
| D Additive A-187 | 2 |

B-components B7 to B9

| Raw material | B7 | B8 | B9 |
|---|---|---|---|
| B1 Amine Ancamine ®1922 | 12 | 12 | 12 |
| B2 Amine Jeffamine ®RFD-270 | 22 | 22 | 22 |
| B3 Amine ATBN ®1300x16 | 15 | | |
| B3 Amine Jeffamine ®THF-100 | | 15 | |
| B3 Amine Jeffamine ®THF-170 | | | 15 |
| D Accelerator ®2950 | 5 | 5 | 5 |
| E Filler HDK 18 | 46 | 46 | 46 |

Results

| Test | A2 + B7 | A2 + B8 | A2 + B9 |
|---|---|---|---|
| Modulus of | 1100 | 1000 | 1200 |
| elasticity¹ | | | |
| TSS¹ | 32 | 30 | 30 |
| I-Peel¹ at 23° C. | 31 | 34 | 29 |
| I-Peel¹ −30° C. | 17 | 7 | 15 |
| I-Peel² at 23° C. | 39 | 39 | 37 |

¹Curing 4 h RT + 30 min 85° C.
²Curing 7 d RT

1. A curing agent component for a two-component epoxy adhesive made of a component A comprising an epoxy resin and a curing agent component B, wherein the curing agent component comprises
B1) at least one aliphatic acyclic polyether amine with at least 2 amino groups and
B2) at least one polyamine selected from a phenalkamine or an aliphatic polyether amine containing at least one acyclic alkoxylate segment and at least one cycloaliphatic segment,
and optionally
B3) at least one amine compound selected from an amine-terminated rubber, an amine-terminated poly(tetramethylene ether glycol) and an amine-terminated poly(tetramethylene ether glycol)-poly(propylene glycol) copolymer.

2. The curing agent component according to claim 1, wherein the aliphatic alicyclic polyether amine is selected from 4,7-dioxaoctane-1,10-diamine, 3,6-dioxaoctane-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine, 4,7,10-trioxatridecane-1,13-diamine and higher oligomers of these diamines.

3. The curing agent component according to claim 1, wherein at least one alicyclic alkoxylate segment is one or more ethoxylate groups, one or more propoxylate groups or a mixture of ethoxylate and propoxylate groups.

4. The curing agent component according to claim 1, wherein the weight ratio of the amine component B1 to the amine component B2 in the curing agent component B is in the range of 2:1 to 1:3.

5. The curing agent component according to claim 1, wherein the curing agent component one or more of the amine components B1), B2) and optionally B3) are present in the form of an adduct with an epoxy resin.

6. The curing agent component according to claim 1, wherein the curing agent component B contains
10 to 20 wt. % aliphatic alicyclic polyether amine B1),
15 to 40 wt. % polyamine B2),
0 to 20 wt. % amine compound B3),
0 to 50 wt. % fillers and/or thixotropic additives,
0 to 5 wt. % adhesive promoters and/or additional additives and
0 to 5 wt. % accelerators.

7. The curing agent component according to claim 1, wherein at least one cycloaliphatic segment is a cycloaliphatic group in the main chain of the aliphatic polyether amine B2).

8. The curing agent component according to claim 1, wherein the aliphatic polyether amine (component B2) is an amine-terminated cycloaliphatic ethoxylate or an amine-terminated cycloaliphatic propoxylate.

9. A two-component epoxy adhesive made of a component A comprising an epoxy resin and a curing agent component B, wherein the curing agent component is a curing agent component according to claim 1.

10. The two-component epoxy adhesive according to claim 9, wherein component A also comprises at least one impact strength modifier.

11. The two-component epoxy adhesive according to claim 9, wherein the component A
40 to 80 wt. % at least one epoxy resin,
10 to 40 wt. % at least one impact strength modifier,
0 to 50 wt. % fillers and/or thixotropic additives, and
0 to 5 wt. % adhesive promoters and/or additional additives
are present.

12. The two-component epoxy adhesive according to claim 9, wherein the epoxy resin comprises a bisphenol A diglycidyl ether, a bisphenol F diglycidyl ether, a bisphenol A/F diglycidyl ether, a novolac epoxy resin or mixtures thereof.

13. The two-component epoxy adhesive according to claim 10, wherein at least one impact strength modifier is selected from
a) a liquid rubber containing an epoxy group-terminated impact strength modifier that can be obtained from the reaction of an isocyanate-terminated prepolymer with an epoxy resin that comprises a primary or secondary hydroxy group containing epoxy compound,
b) a core-shell polymer, particularly made from a core of elastic acrylate or butadiene polymer and a shell of a rigid thermoplastic polymer and/or
c) a core-shell rubber.

14. A component B as curing agent component in a two-component epoxy adhesive, wherein component B comprises
B1) at least one aliphatic alicyclic polyether amine with at least 2 amino groups and
B2) at least one polyamine selected from a phenalkylamine or an aliphatic polyether amine containing at least one alicyclic alkoxylate segment and at least one cycloaliphatic segment,
and optionally
B3) at least one amine compound selected from an amine-terminated rubber, an amine-terminated poly(tetramethylene ether glycol) and an amine-terminated poly(tetramethylene ether glycol)-poly(propylene glycol) copolymer.

15. A component B as curing agent component in a two-component epoxy adhesive wherein component B comprises
B) at least one aliphatic alicyclic polyether amine with at least 2 amino groups; and
B2) at least one polyamine selected from a phenalkylamine or an aliphatic polyether amine containing at least one alicyclic alkoxylate segment and at least one cycloaliphatic segment;
and optionally
B3) at least one amine compound selected from an amine-terminated rubber, an amine-terminated poly(tetramethylene ether glycol) and an amine-terminated poly(tetramethylene ether glycol)-poly(propylene-glycol) copolymer wherein the curing agent component is defined according to claim 2.
